(19) United States
(12) Patent Application Publication
(10) Pub. No.: US 2009/0135697 A1
(43) Pub. Date: May 28, 2009

(54) METHOD FOR DISTINGUISHING OPTICAL DISCS

(76) Inventors: Chia-Hsing Hsu, Taoyuan County (TW); Yi-Long Hsiao, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/247,240

(22) Filed: Oct. 8, 2008

(30) Foreign Application Priority Data
Nov. 23, 2007 (TW) 096144697

(51) Int. Cl. G11B 27/36

(52) U.S. Cl. 369/53.41; G9B/27.052

(57) ABSTRACT

The invention is to provide a method for distinguishing optical discs, which first locks a focus on a data layer of an optical disc to cross the grooves and the lands of the optical disc, then starts testing and counting the time for testing, records a detected RF signal, checks if the time for testing reaches a predetermined time, continues locking the focus on the data layer to test if it has not, finds out the maximum intensity of the detected RF signal among the recorded RF signals, and compares the maximum intensity of the detected RF signal with the parameters regarding formats of optical discs previously stored in order to correctly distinguish the optical disc.

### BACKGROUND OF THE INVENTION

1. Field of the Invention

The present invention relates to a method for distinguishing optical discs, and more particularly to a method for recognizing re-writable optical discs when optical disc drives write/read the optical discs.

2. Description of the Prior Art

Typically, a common optical disc drive utilizes a physical means to distinguish a format of an optical disc after the optical disc is positioned in order to write/read the optical disc. The optical disc drive is configured with the best signal processing and servo system parameters for reading/writing an optical disc of each format, thereby reading/writing data on the optical disc correctly.

FIG. 1 illustrates the conventional method for distinguishing an optical disc: When distinguishing an optical disc W, by means of a pulse voltage V, driving an object lens 1 in a pick-up head H to move up/down, controlling a focus of a projecting beam across a data layer L of the optical disc W, and then the data layer L with the capability of reflection reflects the projecting beam back to the pick-up head H to cross an optical energy converter 2 of the pick-up head H. The optical energy converter 2 includes four optical-receiving parts A, B, C, and D, which are of four equal partitions. The four optical-receiving parts are utilized for receiving reflected luminous flux from respective different areas, and a Sub Beam Add Signal (SBAD) representing total intensity of reflected lights is generated by the signal processing apparatus 3 according to total intensity of reflected lights received by the four optical-receiving parts A, B, C and D. Also, the signal processing apparatus 3 generates an RF (radio frequency) signal corresponding to the intensity of the SBAD signal as a data signal. Utilizing the intensity of reflected lights received by the optical-receiving parts A, B, C, and D and the calculation of (A+C)-(B+D) (each letter represents the intensity of the reflected light received by that optical-receiving part) generates a Focus Error(FE) signal, which is further utilized for locking the focus on the data layer L.

Optical discs of different formats, such as CD-ROM, CD-R, CD-RW, DVD-ROM, DVD-R, and DVD-RW, are composed of different dyes and materials, which make data layers of different formats, have different reflectance. Thus, the conventional method for distinguishing optical discs moves the object lens 1 up, and when the focus of the projecting beam passes through a blank data layer, the data layer reflects an SBAD signal with maximum intensity. Accordingly, the conventional method tests for SBAD signals corresponding to optical discs of each format, analyzing distribution and intensity of signals corresponding to the optical discs of each format, configuring thresholds of the SBAD signals corresponding to each format according to the intensity of the SBAD signals, which will be stored into the memory apparatus of the optical discs as parameters for distinguishing the formats of the optical discs.

However, the foregoing method basically uses a blank optical disc for testing. When the optical discs are recorded with data, some of the optical discs have darker marking traces on the grooves. If the projecting beam for testing projects onto the darker marking traces on the grooves of the data layer by coincidence, it will make the intensity of the generated SBAD signals decrease, thereby causing optical discs of different formats to probably have the same intensity of SBAD signals. For example, the wave pattern regarding the SBAD signal of a read-only disc or a write-once disc is overlapped with that of a rewritable disc, making it become unable to distinguish the optical disc correctly, namely erroneous recognition. Accordingly, parameters previously configured cannot be available to acquire correct information about the format of the optical disc so that the optical disc cannot be recognized properly. As a result, the parameters need to be configured again, which costs additional time and decreases performance of the optical disc drive. Thus, there are still certain problems in detection of the reflected signals of the data layer on the optical disc of the conventional method for distinguishing optical discs.

### SUMMARY OF THE INVENTION

It is therefore one objective of the present invention to provide a method for distinguishing optical discs, utilizing a focus locked on a data layer of an optical disc that makes the focus swing between lands and grooves. Then, the maximum intensity of the detected RF signal is employed for comparison to distinguish the optical disc correctly.

To achieve the foregoing objective of the present invention, the method of the present invention first locks the focus of a projecting beam onto the data layer of the optical disc in order to cross the lands and the grooves. The method next starts to count time and record a detected RF signal. Then, it checks whether the time for testing reaches a predetermined time. If the time for testing has not reached the predetermined time yet, it continues locking the focus on the data layer for testing continually. If the time for testing has already reached the predetermined time, the maximum intensity of the detected RF signal will be found out, and a value regarding the maximum intensity of the detected RF signal will be compared with parameters regarding formats of the optical discs previously stored in order to determine a format of the optical disc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the process of the conventional method for distinguishing optical discs.

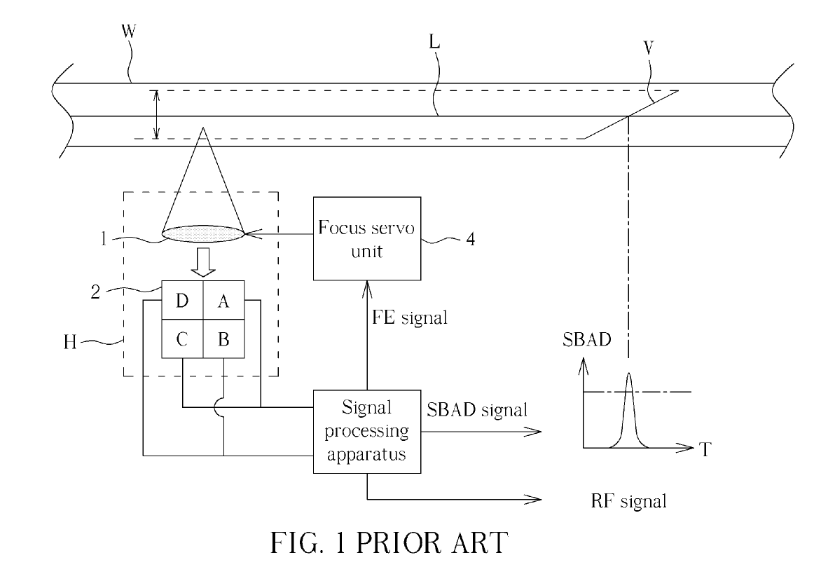

FIG. 2 is a diagram illustrating the process of the method for distinguishing optical discs according to one preferred embodiment of the present invention.

FIG. 3 is a flow chart illustrating the process of the method for distinguishing optical discs according to one preferred embodiment of the present invention.

### DETAILED DESCRIPTION

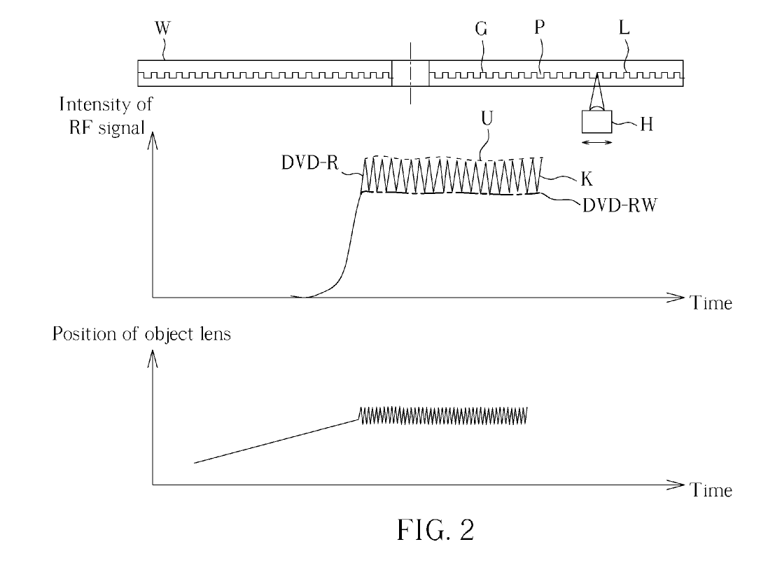

Please refer to FIG. 2, which illustrates the process regarding acquiring the maximum intensity of the RF signal of the method for distinguishing optical discs according to a preferred embodiment of the present invention. In this embodiment, a focus projected by a pick-up head H is at first moved up, and after the focus moves to a data layer L, making an object lens move up and down continually by locking an FE signal on the data layer L in order to stop the focus on the data layer L within a predetermined time for testing. The data layer L, on which there is a groove G, has a function of reflection. The groove G is in the shape of a spiral or concentric circle and is employed for recording data marks. The grooves G are partitioned by flat lands P, which are blank and are not for recording data on.

Take a DVD-R disc as an example. When the focus locks on the data layer L and moves in a small movement along the radial direction of the optical disc to and fro, the focus will cross the groove G and the land P. The reactions of the groove G and the land P in response to the projecting beam are basically the same for a blank DVD-R disc, having reflected lights with maximum intensity, therefore both will acquire RF signals with maximum intensity as shown in Curve U. Thus, a correct RF signal remaining at the maximum intensity is acquired to be utilized for comparison in order to distinguish the optical disc.

On the other hand, if there is data recorded on a groove G, the data marks in the groove G recorded with data will decrease the intensity of the reflected light so as to weaken the generated RF signal when the focus moves across a blank land P and the groove G recorded with data. Nevertheless, the reflected light caused by the blank land P still remains at the maximum intensity, thereby making the intensity of the RF signal vibrate in the interval between a maximum level and a decreased level as shown in the Curve K. Therefore, the light reflected by the blank land P is always provided with the maximum intensity regardless of whether the optical disc is recorded with data. In order to prevent the condition that the weakened RF signal is ineffective compared with the maximum RF signal (e.g. the maximum RF signal of a DVD-RW disc shown in FIG. 2), in the DVD-R disc, the maximum intensity of the RF signal must be found out from the variable intensity of the RF signal and then be compared with parameters regarding formats of optical discs stored in the memory apparatus of the optical disc drive in order to determine in which interval between thresholds of different signals the RF signal with variable intensity falls, regarding each format of the optical discs, to distinguish the format of the optical disc.

Although the foregoing method locks the focus on the data layer and lets the focus move in a small movement to and fro along the radial direction of the optical disc, making the focus cross the lands P and the grooves G in order to acquire the maximum intensity of the RF signal, due to the precision of the manufacture of the optical disc W, the optical disc W has a phenomenon of more or less Eccentricity. As a result, the optical disc W having the phenomenon of Eccentricity will make the lands P and the grooves G be crossed by the focus even if the focus is fixed at a certain position without moving, thereby acquiring the necessary maximum intensity of the RF signal of the optical disc W in order to distinguish the optical disc. Furthermore, although the present invention utilizes a detected RF signal as comparison, the SBAD signal corresponding to the RF signal is also available for comparison, which also falls in the scope of the present invention.

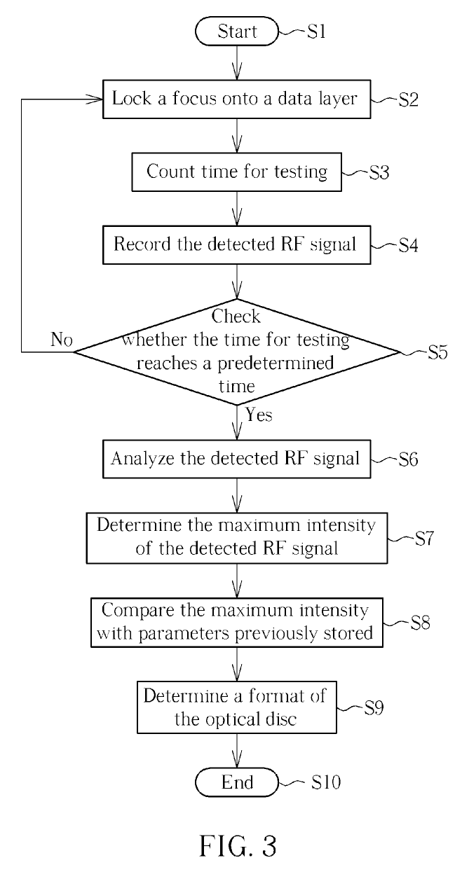

FIG. 3 is a flow chart of the method for distinguishing optical discs according to one preferred embodiment of the present invention. Detailed descriptions of the method the present invention employs for the focus to be locked on the data layer, and acquiring the maximum intensity of the RF signal in order to distinguish the optical disc, are illustrated as follows. The step S1 starts to distinguish an optical disc and then the process goes to the step S2. In step S2, the optical disc is positioned, and a focus projected by a pick-up head is locked on a data layer. Then, the focus moves in a small movement to cross lands and grooves. In step S3, start to count time in order to perform a test within a predetermined time. When the process goes to step S4, record the detected RF signal simultaneously, and then it goes to step S5. In step S5, check whether the time for testing reaches the predetermined time. If the predetermined time has not been reached, it goes to step S2, continually locking on the data layer and performing the test continually. If the predetermined time has already been reached, it goes to step S6, analyzing the variations of the detected RF signal recorded in step S4. Determine the maximum intensity of the detected RF signal from the recorded RF signal in step S7. After step S7, it goes to step S8, which compares the maximum intensity of the RF signal with parameters regarding formats of optical discs stored in a memory apparatus of the optical disc drive. Following, the process goes to step S9, determining the format that the optical disc belongs to according to the comparison result. Finally, the process of distinguishing optical discs ends in step S10.

By the steps mentioned above, the method of the present invention makes the focus of the projecting beam move in a small movement to and fro between the lands and the grooves by locking the focus on the data layer of the optical disc to record the detected RF signal. Regardless of whether the optical disc has already been recorded with data, the focus moving to the land can ensure that a blank place on the optical disc generates the RF signal with maximum intensity. Accordingly, the generated maximum RF signal is compared with parameters regarding formats of optical discs previously stored to distinguish the optical disc correctly. Therefore, the method of the present invention prevents the condition that an optical disc that has been recorded with data influences the intensity of the detected RF signal. Consequently, an erroneous recognition is avoided, thereby increasing the performance of the optical disc drive.

Those skilled in the art will readily observe that numerous modifications and alterations of the device and method may be made while retaining the teachings of the invention.

What is claimed is:

1. A method for distinguishing optical discs, comprising:
(1) locking a focus of a projecting beam on a data layer of an optical disc to cross lands on the data layer;
(2) starting to count time;
(3) recording a detected RF signal;
(4) checking whether the time for testing reaches a predetermined time, if yes, go to step (5); otherwise, go to step (1)
(5) finding out the maximum intensity of the detected RF signal from the recorded RF signal;
(6) Comparing the maximum intensity of the detected RF signal with parameters regarding formats of optical discs stored previously to determine a format of the optical disc.

2. The method of claim 1, wherein step (1) comprises:
the focus crosses the lands and the grooves when the focus is locked on the data layer.

3. The method of claim 2, wherein the focus crosses the lands and the grooves along a radial direction of the optical disc.

4. The method of claim 2, wherein the focus moves in a small movement to cross the lands and the grooves when the focus is locked on the data layer of the optical disc.

5. The method of claim 2, wherein the lands and the grooves are crossed by the focus due to Eccentricity of the optical disc when the focus is locked on the data layer of the optical disc.

6. The method of claim 1, wherein the RF signal can also be replaced with the corresponding SBAD signal.

7. The method of claim 1, wherein step (6) comprises:
the parameters regarding the formats of the optical discs stored previously are thresholds of signals corresponding to each format of the optical discs.

8. The method of claim 7, where step (6) comprises:
comparing the maximum intensity of the detected RF signal with intervals between thresholds of different signals regarding each format of the optical discs to determine in which interval the detected RF signal falls in order to distinguish a format of the optical disc.
